(19) United States
(12) Patent Application Publication
(10) Pub. No.: US 2016/0069533 A1
(43) Pub. Date: Mar. 10, 2016

(54) REFLECTOR ASSEMBLY HAVING A PLURALITY OF REFLECTORS AND SEMICONDUCTOR LIGHT SOURCES

(71) Applicant: OSRAM GMBH, München (DE)

(72) Inventor: Tobias Schmidt, Augsburg (DE)

(73) Assignee: OSRAM GmbH, Munich (DE)

(21) Appl. No.: 14/786,568

(22) PCT Filed: Apr. 24, 2014
(86) PCT No.: PCT/EP2014/058297

§ 371 Date: Oct. 23, 2015

(30) Foreign Application Priority Data
Apr. 25, 2013 (DE) 10 2013 207 609.6

(51) Int. Cl. F21V 7/00; F21V 7/04; F21V 7/10; F21V 23/00

(52) U.S. Cl. CPC F21V 7/0083; F21V 23/001; F21V 7/048; F21V 7/10; F21Y 2101/02

(57) ABSTRACT

A reflector assembly for a lighting device including a plurality of reflectors for at least one semiconductor light source each, wherein the reflectors are reflector sub-regions of a common, continuous sheet-metal part and the reflector sub-regions have wing regions bent at least partially from the sheet-metal part. A lighting device includes at least one reflector assembly, wherein at least one semiconductor light source is arranged on the sheet-metal part. A method may be used to produce a reflector assembly, wherein the method includes at least the following steps: introducing slits into a sheet-metal part in order to provide wing regions that can be bent from the sheet-metal part; and bending over the sheet-metal part including bending out the wing regions in order to form at least one reflector. The above can be applied in particular to lamps for general lighting, in particular for area lighting.

### RELATED APPLICATIONS

The present application is a national stage entry according to 35 U.S.C. §371 of PCT application No.: PCT/EP2014/058297 filed on Apr. 24, 2014 which claims priority from German application No.: 10 2013 207 609.6 filed on Apr. 25, 2013, and is incorporated herein by reference in its entirety.

### TECHNICAL FIELD

Various embodiments may relate to a reflector assembly for a lighting device, including a plurality of reflectors for in each case at least one semiconductor light source. The invention furthermore relates to a lighting device including at least one such reflector assembly. Various embodiments may also relate to a method for producing such a reflector assembly. Various embodiments are applicable, in particular, to luminaires for general lighting, in particular for area lighting.

### BACKGROUND

Linear arrangements of a plurality of reflectors have hitherto been provided either by the reflectors being produced individually and then mounted alongside one another on a common carrier, or by transverse lamellae being inserted into a linear reflector trough. A linear reflector trough typically includes a rectilinear, strip-shaped base and laterally with respect thereto obliquely raised, reflective side walls. The transverse lamellae can e.g. be plugged into slots in the side walls or be latched into place or adhesively bonded on the side walls. However, both arrangements are comparatively complicated to produce.

### SUMMARY

The object of the present disclosure is to overcome the disadvantages of the related art at least in part and, in particular, to provide a possibility for the simplified provision of a reflector assembly including a plurality of reflectors, in particular linearly arranged reflectors.

Various embodiments provide a reflector assembly for a lighting device. The reflector assembly includes a plurality of reflectors for in each case at least one semiconductor light source. The reflectors are reflector sub-regions of a common, continuous plate part. The reflector sub-regions include wing region bent out at least partly from the plate part.

This reflector assembly has the advantage that it is produced from a single piece, namely the plate part, such that no connecting techniques for connecting a plurality of parts such as adhesive bonding, soldering, welding, etc. need be used therefor. Simple methods for partly cutting out the wing regions and for reshaping the plate part suffice. The reflector assembly is configurable particularly stably, moreover, on account of its single-piece nature.

A reflector may be a reflector for one semiconductor light source or a (common) reflector for a plurality of semiconductor light sources.

The at least one semiconductor light source may include at least one light emitting diode. In the case where a plurality of light emitting diodes are present, they can emit light in the same color or in different colors. A color can be monochromatic (e.g. red, green, blue, etc.) or multichromatic (e.g. white). Moreover, the light emitted by the at least one light emitting diode can be infrared light (IR LED) or ultraviolet light (UV LED). A plurality of light emitting diodes can generate mixed light; e.g. white mixed light. The at least one light emitting diode can contain at least one wavelength-converting phosphor (conversion LED). The phosphor can alternatively or additionally be arranged in a manner remote from the light emitting diode (“remote phosphor”), e.g. on the reflector sub-region or onto the reflector. The at least one light emitting diode can be present in the form of at least one individually packaged light emitting diode or in the form of at least one LED chip. A plurality of LED chips can be mounted on a common substrate (“submount”). The at least one light emitting diode can be equipped with at least one dedicated and/or common optical unit for beam guiding, e.g. at least one Fresnel lens, collimator, and so on. Instead of or in addition to inorganic light emitting diodes, e.g. based on InGaN or AlInGaP, organic LEDs (OLEDs, e.g. polymer OLEDs) are generally usable as well. Alternatively, the at least one semiconductor light source may include e.g. at least one diode laser.

The fact that the wing regions can be bent out from the rest of the plate part encompasses, in particular, the fact that the wing regions are partly separated from the rest of the plate part, e.g. by one or a plurality of cuts. As a result, they can be bent out at their at least one free edge relative to adjacent regions of the plate part. As a result, the bent-out wing region and, adjacent thereto, the non-bent-out region of the plate part are offset, e.g. offset in a stepped manner, with respect to one another. However, the wing regions are still connected to the rest of the plate part by at least one transition not cut through (also referred to as “material bridge”). The wing regions enable a particularly diverse shaping of the reflectors. The cuts can have been introduced e.g. by a laser separating method.

It is generally preferred for the reflectors to be shell reflectors having correspondingly reflectively embodied inner walls. The reflector sub-regions or the reflectors may generally be specularly reflective or diffusely reflective. At least one semiconductor light source may then radiate light into the reflector through a neck opening or be arranged on the reflector at the neck opening. Light typically emerges at a light exit opening of the reflector opposite the neck opening. The light exit opening generally has a larger cross section than the neck opening.

The plate part can be metallic, e.g. composed of aluminum or steel, but can also consist of thin plastic (“plastic plate”). However, the plate part is not restricted thereto and may e.g. also be a thin metal-clad plastic or the like. The plate part can therefore generally be embodied or referred to as a thin, planar and permanently flexible reflector part.

In one configuration, the plate part is bent to form at least one linear reflector trough, wherein the reflector trough includes a strip-shaped base and laterally with respect thereto in each case at least one bent-up side wall. In particular, the linear reflector trough may include a continuous side wall along the base on each longitudinal side of the base. This configuration enables the shaping of the reflector trough by simple bendings or bends along straight bending lines running parallel to one another, in particular. Such a reflector trough is producible in a simple manner particularly if the plate part itself is already strip-shaped.

In another configuration, the side walls include the reflector sub-regions and bent-out wing regions of the reflector sub-regions are bent into the reflector trough. As a result, the reflectors can be produced by simply bending the wing regions into the reflector trough.

In particular, a reflector can be formed by at least two bent-over wing regions of opposite reflector sub-regions and by sections of the side walls that lie between the wing regions. Such a reflector may be, in particular, a circumferential reflector or shell reflector.

In yet another configuration, the two reflector sub-regions of a common reflector are embodied symmetrically with respect to a central plane that is perpendicular to the base

In one development, the two reflector sub-regions are embodied mirror-symmetrically with respect to the central plane. For this purpose, in particular, two wing regions are present on each side wall per reflector, that is to say four wing regions per reflector. The wing regions of a reflector sub-region are separated by an intervening (central) reflector section of the side wall (which remains on the side wall). The wing regions are arranged in front of and behind said central reflector section in particular in relation to a longitudinal extent of the reflector trough, but are otherwise cut free. For forming a reflector wall bent into the reflector trough, opposite wing regions can be bent into the reflector trough in a manner similar to gates, such that the reflector includes two bipartite reflector walls there. The wing regions can be bent into the reflector trough up to their parallel position or else such that they are situated obliquely with respect to one another. In particular, it is preferred for no or no significant gap through which light could emerge laterally to remain between adjoining wing regions. For this purpose, the wing regions are preferably provided with a width that corresponds to at least half a width of the reflector trough at the corresponding height.

In another development, the two reflector sub-regions are embodied point-symmetrically or rotationally symmetrically through 180° with respect to a central axis that is perpendicular to the base. In order that the reflector walls are embodied transversely with respect to the reflector trough, only one wing region is then present on each side wall per reflector. For forming a reflector wall projecting into the reflector trough, the wing regions can be bent into the reflector trough in a manner similar to gates, although now in particular integrally. In particular, it is preferred for no or no significant gap through which light could emerge laterally to remain between such a wing region and the opposite side wall. For this purpose, the wing regions are preferably provided with a width that corresponds to at least a width of the reflector trough (at the corresponding height).

In one configuration, furthermore, placement regions for arranging the semiconductor light sources are situated on the base. As a result thereof, in particular, the reflectors can serve as shell reflectors for at least one semiconductor light source.

The semiconductor light sources can be arranged on a placement region directly or indirectly. By way of example, a packaged semiconductor light source may be connected by its underside directly to the base of the reflector trough, e.g. by being adhesively bonded thereto. Electrical contacting of a semiconductor light source may take place via contacts on the top side, for example, which contacts can be connected to associated electrical connection lines, in particular conductor semiconductor light source may be a packaged semiconductor light source which bears with at least one electrical contact on the underside directly on an electrical connection line, in particular conductor track, and can be e.g. soldered thereto. The packaged semiconductor light sources can be surface-mountable components (SMT components), in particular. However, the semiconductor light sources may e.g. also be a semiconductor chip, e.g. LED chip, fitted on a substrate on the front side, wherein the substrate bears on the plate part on the rear side.

It is possible, in principle, to arrange, in particular to fix, the at least one semiconductor light source on that side of the base on which the reflector is embodied as well. Without restricting the generality, said side hereinafter is also referred to as the front side of the base. Alternatively or additionally, it is possible for at least one semiconductor light source to be arranged, in particular fixed, on that side of the base which faces away from the reflector. Without restricting the generality, said side hereinafter is also referred to as the rear side of the base. In the case of a rear-side arrangement, the at least one semiconductor light source can send radiation in the direction of the front side in particular through a cutout in the base. Alternatively or additionally, the at least one semiconductor light source can be introduced into a cutout in the base or led through to the front side.

In one configuration, moreover, electrical connection lines run to the placement regions on the base. A simple electrical connection of the semiconductor light sources is made possible as a result. The semiconductor light sources can be interconnected in series and/or in parallel with one another by the electrical connection lines. The electrical connection lines may be cables, wires or conductor tracks, for example. In the case where non-insulated connection lines, e.g. conductor tracks, are used, they can bear in particular via an electrically insulating layer on the base.

Very generally, a course of the electrical connection lines is not restricted to any region of the plate part. They can e.g. also run on regions of the plate part which do not correspond to a base of a reflector trough.

In one configuration, moreover, wing regions that cross electrical connection lines cross the connection lines in a spaced-apart manner. As a result, it is possible to prevent undesired electrical contacting with exposed connection lines and undesired mechanical loading of the connection lines by the wing regions.

In another configuration, the reflector assembly includes a plurality of reflector troughs. As a result, by a one-piece reflector assembly, a particularly high number of reflectors can be provided, in particular also over a large area. This is advantageous in particular for surface luminaires.

In another configuration, the plurality of reflector troughs are surrounded by a common frame that holds the reflector troughs. As a result, a plurality of reflector troughs can be provided on the same reflector assembly in a simple manner, which reflector troughs are shapeable in a diverse fashion and largely independently of one another.

The plate part can generally have at least one cutout. The cutout can be introduced into the plate part for example by local cutting out, stamping out, etc. The at least one cutout can serve in particular for leading through a semiconductor light source and be introduced e.g. in the base of a reflector trough.

Various embodiments also provide a lighting device, including at least one reflector assembly as described above, wherein at least one semiconductor light source is arranged on the plate part. The lighting device can be embodied analogously to the reflector assembly and have the same advantages.

In this regard, in one development, the lighting device includes at least one reflector assembly including at least one reflector trough, wherein the at least one semiconductor light source is arranged on the base of the reflector trough. In one configuration, moreover, at least one electrical connection line runs on the base of the reflector trough.

In one development, moreover, the semiconductor light sources and associated connection lines arranged in a reflector trough, are arranged on a common substrate. As a result, they can be arranged on the plate part in a particularly simple and time-saving manner. In this regard, by arranging, in particular fixing, the common substrate on the plate part (e.g. by adhesively bonding a rear side of the substrate), all functional elements situated thereon are concomitantly arranged, in particular fixed, in one work step. Moreover, an alignment of the functional elements in the case of the arrangement can be obviated.

In another development, the common substrate is a strip-shaped—flexible or rigid—printed circuit board which together with the semiconductor light sources and the connection lines forms a so-called luminous strip, in particular an LED strip. Such luminous strips are commercially available e.g. in the form of LED strips from Osram, e.g. of the LINEARLight type. The use of a luminous strip has the further advantage that it is fixable to the plate part in a positively locking and/or force-locking manner by holding lugs, for example. In this case, the holding lugs are in particular likewise sub-regions that can be bent out onto the plate part.

The type of the lighting device is not restricted and may be a lamp or a luminaire, for example. Particular preference is given to a configuration as a luminaire for general lighting, in particular for area lighting. The luminaire may be, in particular, a ceiling luminaire or a wall luminaire.

Various embodiments also provide a method for producing a reflector assembly as described above.

The method may include at least the following steps: (i) introducing slots into a plate part for providing wing regions that can be bent out from the plate part; and (ii) bending over the plate part including bending out the wing regions for forming at least one reflector, in particular shell reflector.

The method may be embodied analogously to the reflector assembly and/or the lighting device and has the same advantages.

The method may include, in particular in step (ii), bending over the plate part—including bending out the wing regions—for forming at least one linear reflector trough in particular with in each case at least two reflectors. Forming the reflectors may include bending out the wing regions into the associated reflector trough.

Bending over may include, in particular, bending away or angling two sub-regions of the plate part at a common bending line.

In one development, bending over the plate part for forming at least one linear reflector trough includes bending over to the same side along two parallel bending lines. The region between the two bending lines can serve as a base; the two regions laterally with respect to the base can serve as side walls. The wing regions can be bent out at least partly from the side walls. The wing regions can be bent out in particular completely from the side walls, alternatively or additionally can be bent out from the side walls and from the base.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows in plan view a plate part for producing a reflector assembly in accordance with a first embodiment;

FIG. 2 shows the finished reflector assembly from FIG. 1 in a view obliquely from above;

FIGS. 3-6 show the reflector assembly from FIG. 2 in a cross-sectional view with differently fashioned side edges;

FIG. 7 shows the plate part from FIG. 1 with additional electrical wiring and placement with semiconductor light sources;

FIG. 8 shows in plan view a plate part for producing a reflector assembly in accordance with a second embodiment; and

FIG. 9 shows in plan view a plate part for producing a reflector assembly in accordance with a third embodiment.

### DETAILED DESCRIPTION

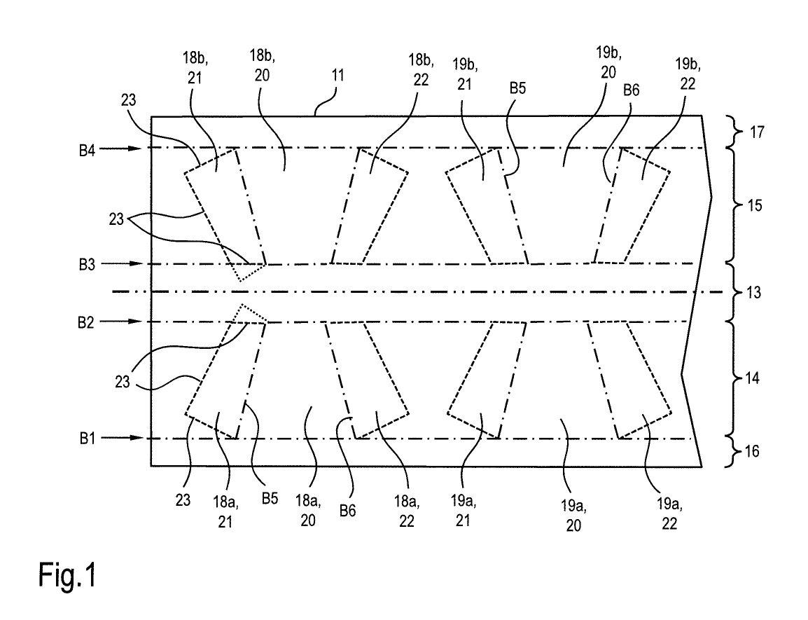

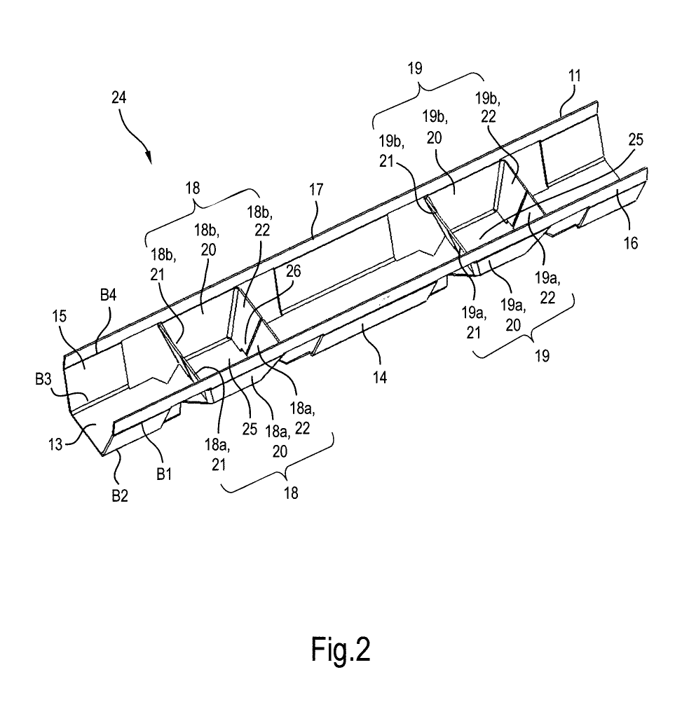

FIG. 1 shows in plan view an excerpt from a plate part 11 for producing a reflector assembly in accordance with a first embodiment. The plate part 11 consists of metal, e.g. steel or aluminum, which is embodied in a reflective fashion at least on one side. The plate part 11 here is embodied in a linearly strip-shaped fashion with a longitudinal axis L. The plate part 11 is partly provided with slots 23 and partly bent over in order to produce the reflector assembly 24 shown in FIG. 2. In this regard, parallel and symmetrically with respect to the longitudinal axis L there are four longitudinally extending bending lines B1, B2, B3 and B4, at which the plate part 11 is bent over. In particular, the plate part 11 is bent up at the inner bending lines B2 and B3 from the plane of the drawing in the direction of the observer. This gives rise to a trench or linear reflector trough 13 to 15 having a central base 13 extending in the longitudinal direction L and two side walls 14 and 15 proceeding laterally therefrom. The base 13 is delimited from the side walls 14 and 15 by the inner bending lines B2 and B3, respectively. The side walls 14 and 15 can be bent over at the outer bending lines B1 and B4 and form side edges 16 and 17 there.

The side walls 14 and 15 in each case have a plurality of reflector sub-regions 18a, 18b, 19a, 19b, wherein in each case two sub-regions 18a, 18b and 19a, 19b are opposite one another and embodied symmetrically in relation to the longitudinal axis L. Adjacent reflector sub-regions 18a, 19a and 18b, 19b of the same side wall 14 and 15, respectively, are arranged equidistantly with respect to one another.

Each of the reflector sub-regions 18a, 18b, 19a, 19b has a central region 20 extending continuously between the two associated bending lines B1, B2 and B3, B4, respectively. On both sides of the central regions 20, as viewed in a longitudinal extension along the longitudinal axis L, there are situated regions which hereinafter are designated as “wing regions” 21, 22 and which are delimited from the central region 20 by bending lines B5, B6. The bending lines B5, B6 extend rectilinearly over the entire height of the central region 20 between the bending lines B1, B2 and B3, B4, respectively. In this case, the bending lines B5, B6 run obliquely, specifically in such a way that the central region 20 widens or is increased in terms of its width from the inner bending line B2 and respectively B3 toward the outer bending line B1 and respectively B4. The central region 20 therefore has the shape of an isosceles trapezoid.

The wing regions 21, 22 are separated from the rest of the plate part 11 by respectively continuous slots 23. The wing regions 21 and 22 are therefore still linked with the rest of the plate part 11 only at the bending lines B5 and B6, respectively, and can thus be bent out from the plate part 11 at the bending line B5 and B6, respectively.

The wing regions 21, 22 can also alternatively be cut right into the base 13, as indicated by the dotted lines. As a result, the wing regions 21, 22 acquire a larger area, which increases a luminous efficiency.

FIG. 2 shows in a view obliquely from above the reflector assembly 24 bent over to completion from the plate part 11. The side walls 14 and 15 and the base 13 form the linear reflector trough 13 to 15 with the side edges 16 and 17 adjacent thereto. The side edges 16 and 17 can constitute part of the reflector trough 13 to 15.

The reflector regions 18a and 18b, 19a and 19b form respective reflectors 18 and 19. The reflectors 18 and 19 are embodied in each case as truncated-pyramid-shaped shell reflectors. The four reflective side walls are composed of the central regions and opposite wing regions 21 and 22 bent perpendicularly into the reflector trough 13 to 15. Since mutually adjoining wing regions 21 and 22 of opposite reflector sub-regions 18a, 18b and 19a, 19b, respectively form the reflective side walls situated in the reflector trough 13 to 15, their width amounts to half a width of the reflector trough 13 to 15 or of the distance between the side walls 14, 15 at the corresponding height. This prevents a formation of a gap between mutually adjoining wing regions 21 and 22 or at least keeps it small enough that no significant light loss results therefrom.

That section of the base 13 that is bounded by the wing regions 21 and 22 may likewise be reflective and serves as a placement region 25 for in each case at least one semiconductor light source.

The wing regions 21 and 22 are also removed from the base 13 here at their underside, such that they can reach as far as the base 13 in the bent-out state.

The wing regions 21 and 22 in each case have a cutout 26 (not depicted in FIG. 1) at their underside facing the base 13, wherein the cutouts 26 adjoin one another and jointly form a central lead-through.

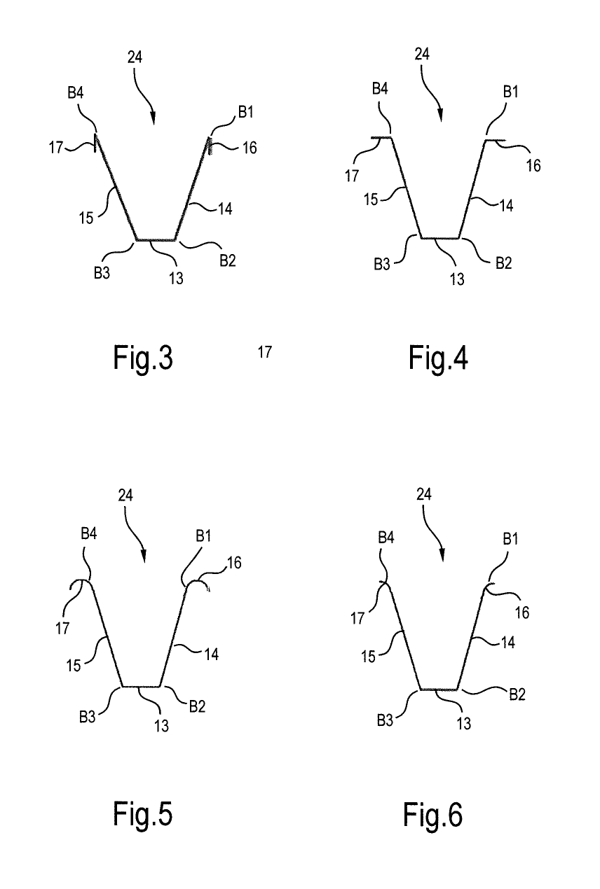

FIG. 3 shows the finished reflector assembly 24 from FIG. 1 in a cross-sectional view with differently fashioned side edges 16 and 17. While the side edges 16 and 17 rise perpendicularly in the variant of the reflector assembly 24 as shown in FIG. 2, said side edges are bent downward perpendicularly along the outer bending lines B1 and B4 in FIG. 3. In FIG. 4, by contrast, the side edges 16 and 17 are bent over horizontally along the outer bending lines B1 and B4. The side edges 16 and 17 are embodied in a manner curved downward in cross section starting from the bending line B1 and B4, respectively, in FIG. 5, and in a manner curved toward the side in FIG. 6.

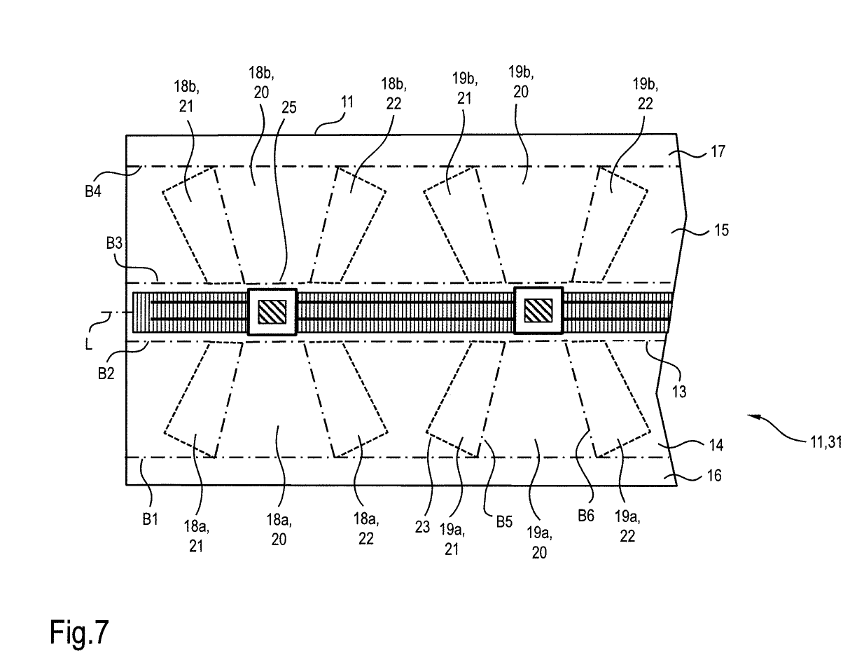

FIG. 7 shows the plate part 11 with additional electrical wiring and placement with semiconductor light sources. In addition to the plate part 11 from FIG. 1, now the strip-shaped base 13 is occupied in each case with a semiconductor light source in the form of a light emitting diode 27 at the placement regions 25. The type of the light emitting diodes 27 is arbitrary, in principle; they are embodied here as LED chips which are fixed, e.g. adhesively bonded, to the placement region 25 via an electrically insulating substrate 28. Electrical connection lines in the form of two conductor tracks 29 running parallel run between the placement regions 25 or the light emitting diodes 27. The conductor tracks 29 are applied on the base 13 via an electrically insulating layer 30 and supply the light emitting diodes 27 with electrical energy. In the finished bent-over state of the plate part 11, the conductor tracks 29 run through the cutout 26 of the wing regions 21 and 22, such that the wing regions 21 and 22 cross the conductor tracks 29 in a spaced-apart fashion.

The plate part 11 bent over to completion and equipped in this way can serve as a lighting device 31.

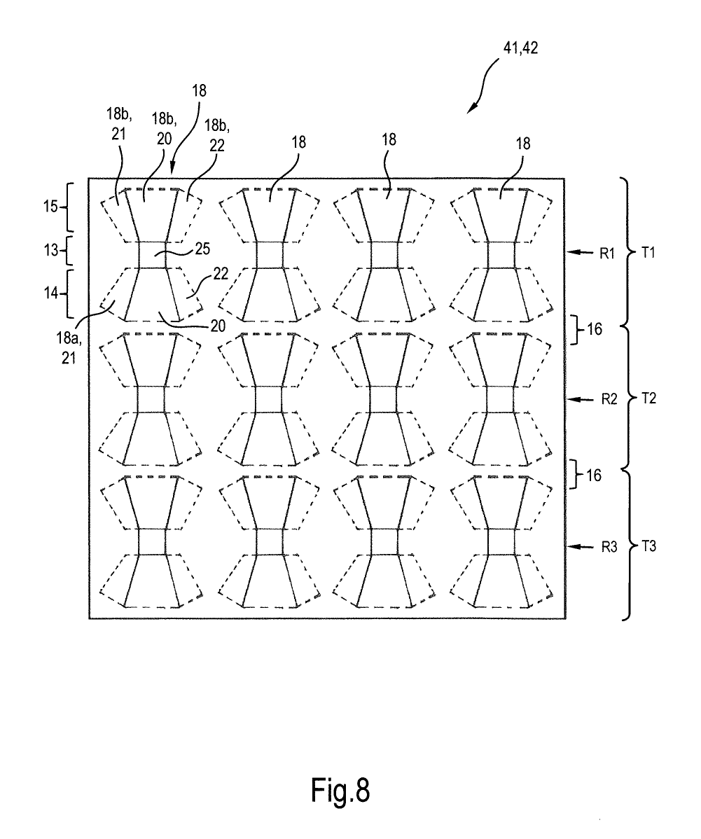

FIG. 8 shows in plan view a simplified schematic diagram of a plate part 41 for producing a reflector assembly 42 in accordance with a second embodiment.

The plate part 41 differs from the plate part 11 in that now it has three rows R1, R2, R3 of in each case four reflectors 18 or 18a, 18b arranged linearly, rather than only one row. The plate part 41 can thus be bent to form a reflector assembly 42 including three continuous linear reflector troughs T1, T2, T3 similar to the reflector troughs 13 to 15. Adjacent reflector troughs T1 to T3 are connected to one another by identical side edges 16.

Alternatively, the reflector sub-regions 18a, 18b, etc. can also be completely bent out from the plate part 41 and may subsequently be additionally fixed, in particular, e.g. by a cover.

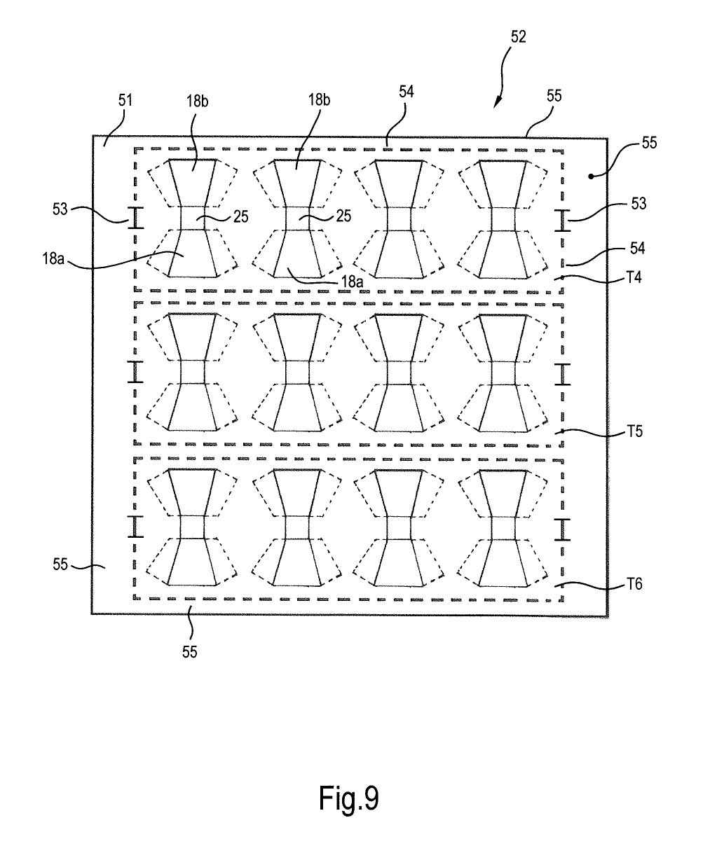

FIG. 9 shows in plan view a simplified schematic diagram of a plate part 51 for producing a reflector assembly 52 in accordance with a third exemplary embodiment. The plate part 51 is embodied in a manner similar to the plate part 41, but now the rows of in each case four reflectors 18a, 18b forming common reflector troughs T4, T5 or T6 are cut out from the plate part 51 in rectangular fashion apart from a transition 53 at the end sides of the base 13. The associated rectangular cuts 54 therefore run between the two transitions 53. This reflector assembly 52 has the advantage that the reflector troughs T4 to T6 now are no longer linked at their side edges, but rather can be shaped independently of one another. The reflector troughs T1 to T3 are nevertheless linked with one another mechanically by a common, circumferential frame 55 that holds the reflector troughs T4 to T6 at their transitions 53. The reflector troughs T4 to T6 can also be electrically connected to one another, e.g. by virtue of common conductor tracks crossing the transitions 53 and running on the common frame 55.

Although the invention has been more specifically illustrated and described in detail by the embodiments shown, nevertheless the invention is not restricted thereto, and other variations can be derived therefrom by the person skilled in the art without departing from the scope of protection of the invention.

Generally, “a(n)”, “one”, etc. can be understood to mean a singular or a plural, in particular in the sense of “at least one” or “one or a plurality”, etc., as long as this is not explicitly excluded, e.g. by the expression “exactly one”, etc.

Moreover, a numerical indication can encompass exactly the indicated number and also a customary tolerance range, as long as this is not explicitly excluded.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A reflector assembly for a lighting device, comprising:
a plurality of reflectors wherein each reflector of the plurality of reflectors is configured for at least one semiconductor light source,
wherein the reflectors are reflector sub-regions of a common, continuous plate part and
the reflector sub-regions comprise wing regions bent out at least partly from the plate part.

2. The reflector assembly as claimed in claim 1,
wherein at least one linear reflector trough bent from the plate part comprises:
a strip-shaped base and at least two sidewalls adjacent to the strip-shaped base, the sidewalls bent-up from the strip-shaped base,
wherein each of the at least two sidewalls comprise the reflector sub-regions and each of the respective wing regions of the reflector sub-regions are bent into the reflector trough.

3. The reflector assembly as claimed in claim 2, wherein a reflector is formed by at least two bent-over wing regions of opposite reflector sub-regions and by sections of the side walls that lie between the wing regions.

4. The reflector assembly as claimed in claim 2,
wherein the two reflector sub-regions of a common reflector are embodied symmetrically with respect to a central plane that is perpendicular to the base.

5. The reflector assembly as claimed in Claim 2,
wherein placement regions for arranging the semiconductor light sources are situated on the base.

6. The reflector assembly as claimed in claim 5, wherein electrical connection lines run to the placement regions on the base.

7. The reflector assembly as claimed in claim 6, wherein wing regions that cross electrical connection lines cross the connection lines in a spaced-apart manner.

8. The reflector assembly as claimed in claim 2,
wherein the reflector assembly comprises a plurality of reflector troughs surrounded by a common frame that holds the reflector troughs.

9. The reflector assembly as claimed in claim 2,
wherein at least one semiconductor light source is arranged on the plate part.

10. The reflector assembly as claimed in claim 9,
wherein the at least one semiconductor light source is arranged on the base of the reflector trough.

11. A method for producing a reflector assembly comprising:
introducing slots into a plate part for providing wing regions that can be bent out from the plate part;
bending over the plate part including bending out the wing regions for forming at least one reflector.

12. A reflector assembly for a lighting device comprising:
at least one linear reflector trough bent from a common, continuous plate part, the
at least one linear reflector trough comprising:
a strip-shaped base formed from the plate part;
a first sidewall bent from the plate part adjacent to the strip-shaped base, the first sidewall comprising a plurality of reflector sub-regions, the plurality of reflector sub-regions comprising respective wing regions bent into the at least one linear reflector trough from the first sidewall; and
and a second sidewall bent from the plate part adjacent to the strip-shaped base and opposite the first sidewall, the second sidewall comprising a plurality of further reflector sub-regions, the plurality of further reflector sub-regions comprising respective further wing regions bent into the at least one linear reflector trough from the second sidewall;
wherein the plurality of reflector sub-regions, the plurality of further reflector sub-regions, the wing regions, and the further wing regions, form a plurality of reflectors within the at least one linear reflector trough.
